(19) United States
(12) Patent Application Publication
(10) Pub. No.: US 2013/0259989 A1
(43) Pub. Date: Oct. 3, 2013

(54) APPARATUS AND METHOD FOR STERILIZING AND PRESERVING FRESH PRODUCTS

(71) Applicant: Shoichi Nakamura, Higashichikuma-gun (JP)

(72) Inventor: Shoichi Nakamura, Higashichikuma-gun (JP)

(21) Appl. No.: 13/703,791

(22) PCT Filed: Apr. 2, 2012
(86) PCT No.: PCT/JP2012/058955

§ 371 Date: Dec. 12, 2012

(51) Int. Cl. A23L 3/3445

(52) U.S. Cl. CPC A23L 3/3445
USPC 426/316; 422/294

(57) ABSTRACT

An apparatus and a method for sterilizing and preserving fresh products are provided by making the ozone gas and the carbon dioxide in a state of the gas mist to be in contact with the fresh product to sterilize and to keep freshness of the fresh product. It includes a gas supplying means 10 for supplying ozone gas, carbon dioxide, or mixed gas of them, a liquid supplying means 20 for supplying liquid, a gas mist generating means 30 for generating gas mist which is obtained by smashing and dissolving the gas supplied from the gas supplying means 10 and the liquid supplied from the liquid supplying means 20, a fresh food packing bag 60 for accommodating a fresh food 100 inside thereof and for forming a space for enclosing, inside thereof, the gas mist supplied from the gas mist generating means 30, and a degassing means for withdrawing the gas mist from the fresh food packing bag 60, wherein the ozone gas and the carbon dioxide gas are in the state of gas mist to be in contact with the fresh product 100 to sterilize and to keep freshness of the fresh product 100.

### TECHNICAL FIELD

The present invention relates to an apparatus and a method for sterilizing and preserving fresh products by using ozone gas, carbon dioxide, or mixed gas of them to sterilize fresh products and to improve the shelf life.

In this patent application, “fresh products” or “a fresh product” (one kind of fresh products) means fish and seafood, meats, green goods, fruits, seaweed, fresh flowers or the like which are necessary to be provided in fresh states to customers.

### BACKGROUND ART

Ozone is isotope of oxygen consisting of three oxygen atoms and is known to have a strong oxidation power. By the oxidation power, ozone can have effects of good sterilization, inactivation of virus, deodorization, bleaching, removing of organic matter, or the like. Therefore, a washer or the like has been developed in which ozone water including ozone gas dissolved into water is used to clean or sterilize a fresh product.

On the other hand, carbon dioxide has antibacterial effect, antiseptic action, action of protection from insects so that it can suppress generation of bacteria, fungus, destructive insects or the like. Specifically, without toxicity such as in pesticide, it can remove the destructive insects even in a state of eggs, larvae, or pupae, and is used also as agrichemicals. In addition, since carbon dioxide also has a freshness-keeping effect or an antioxidant punch by suppressing to draw breath of fruit and vegetables, in the past, for example, carbon dioxide has been filled in a package of a fresh product in order to preserve the fresh product.

Further, an apparatus for sterilizing and preserving a fresh product by combining these ozone gas and carbon dioxide has already been developed (see, for example, a patent document 1).

### PRIOR ART DOCUMENT

### Patent Document

Patent document 1: Japanese Laid-Open Patent Publication (Kokai) No. 10-327829

### SUMMARY OF THE INVENTION

### Problems to be Solved by the Invention

By the way, it has been known that gas has, as its property, a higher rate of absorption when gas in connection with mist contacts with a fresh product rather than when it alone contacts with a fresh product. Therefore, by penetrating mist along with such the ozone gas or carbon dioxide into a fresh product, microbes in the fresh product can be easily removed, and the effect to keep freshness can be increased, and further the amount of water in the fresh product can be prevented from being lowered. However, such an apparatus and method have not been provided in the past.

Accordingly, in view of the above circumstances, an object of the present invention is to provide an apparatus and a method for sterilizing and preserving fresh products or the like and for keeping freshness of the fresh product by contacting the ozone gas and the carbon dioxide in a state of gas mist to the fresh product.

### Means to Solve the Problems

To solve the problems, according to the present invention, there is provided an apparatus for sterilizing and preserving fresh products characterized in that the apparatus includes: a gas supplying means for supplying ozone gas, carbon dioxide, or mixed gas of them (herein after referred to as “gas”) ; a liquid supplying means for supplying liquid; a gas mist generating means for generating mist (herein after referred to as “gas mist”) which is obtained by smashing and dissolving the gas and the liquid supplied from the gas supplying means and the liquid supplying means; a fresh food packing bag for accommodating a fresh food inside thereof and for forming a space for enclosing, inside thereof, the gas mist supplied from the gas mist generating means; and a degassing means for withdrawing the gas mist from the fresh food packing bag; the ozone gas and the carbon dioxide in a state of the gas mist being made to be in contact with the fresh product to sterilize and to keep freshness of the fresh product.

Here, it may further include a control means for performing various controls in the apparatus for sterilizing and preserving fresh products.

Also, the gas supplying means may further supply nitrogen gas or mixed gas of ozone gas, carbon dioxide and nitrogen gas.

In addition, the liquid supplying means may be a gas compound liquid generating and supplying means for miniaturizing bubbles of the gas and for involving them in the liquid. The gas compound liquid generating and supplying means preferably miniaturizes the bubbles of gas into microbubbles each of which has a size of 4 to 50 micrometers and involves them into the liquid.

Further, to solve the problems, according to the present invention, there is provided a method for sterilizing and preserving fresh products characterized in that the method includes: (a) a step of withdrawing air from a fresh food packing bag accommodating a fresh product, and of injecting ozone gas mist which is mist (herein after referred to as “gas mist”) obtained by smashing and dissolving ozone gas and liquid; (b) a step of sealing the fresh food packing bag for a predetermined time period t1 so as to make the fresh product to be in contact with the ozone gas mist; (c) a step of withdrawing the ozone gas mist from the fresh food packing bag and of injecting carbon dioxide gas mist which is obtained by smashing and dissolving the carbon dioxide and the liquid; (d) a step of sealing the fresh food packing bag for a predetermined time period t2 so as to make the fresh product to be in contact with the carbon dioxide gas mist; (e) a step of withdrawing the carbon dioxide gas mist from the fresh food packing bag; and (f) a step of sealing the fresh food packing bag to be a vacuum pack, wherein the ozone gas and the carbon dioxide in a state of the gas mist being made to be in contact with the fresh product to sterilize and to keep freshness of the fresh product.

Here, it may further include, between the step (d) and the step (e), (g) a step of withdrawing the gas mist from the fresh food packing bag, and of injecting nitrogen gas mist, which is obtained by smashing and dissolving the nitrogen gas and the liquid, into the fresh food packing bag; and (h) a step of sealing the fresh food packing bag for a predetermined time period t3 so as to make the fresh product to be in contact with the nitrogen gas mist.

Further, to solve the problems, according to the present invention, there is provided a method for sterilizing and preserving fresh products characterized in that the method includes: (a) a step of withdrawing air from a fresh food packing bag which accommodates a fresh product, and of injecting mixed gas mist which is mist (herein after referred to as “gas mist”) obtained by smashing and dissolving mixed gas of ozone gas and carbon dioxide and liquid; (b) a step of sealing the fresh food packing bag for a predetermined time period t3 so as to make the fresh product to be in contact with the mixed gas mist; (c) a step of withdrawing the mixed gas mist from the fresh food packing bag; and (d) a step of sealing the fresh food packing bag to be a vacuum pack, wherein the ozone gas and the carbon dioxide in a state of the gas mist being made to be in contact with the fresh product to sterilize and to keep freshness of the fresh product.

Here, nitrogen gas may be further added to the mixed gas.

Note that, in this application, the smashing and dissolving indicate that liquid is smashed to be fine liquid drops which are then made to be in contact with and mixed with gas (ozone gas, carbon dioxide, or mixed gas of them).

### Effects of the Invention

According to the apparatus and the method for sterilizing and preserving fresh products of the present invention, fresh product is made to be in contact with ozone gas mist and carbon dioxide gas mist so that sterilization, inactivation of virus, prevention of bacteria, fungi, destructive insects, or the like from being generated can be performed as well as freshness of fresh product can be kept and change of properties or deterioration of quality can be suppressed so as to improve the shelf life. Therefore, it becomes possible to reduce agricultural chemicals or preservation agent.

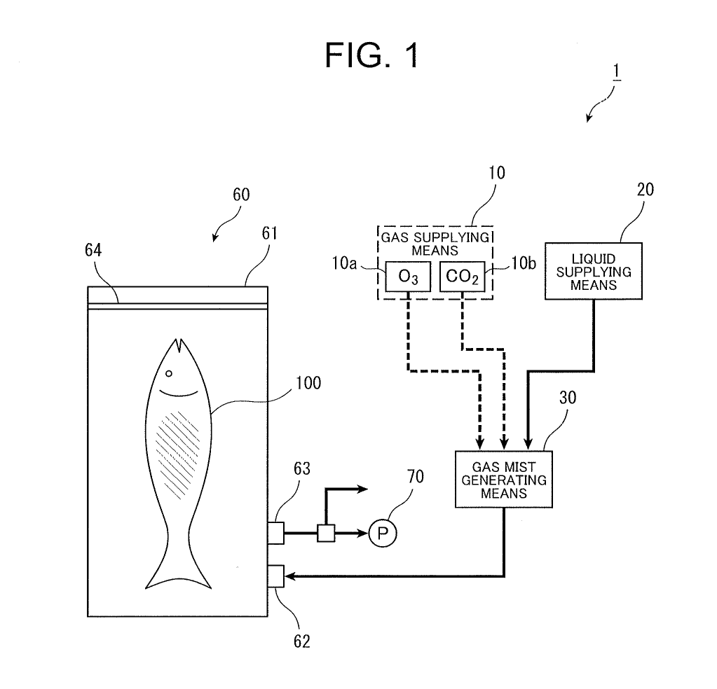

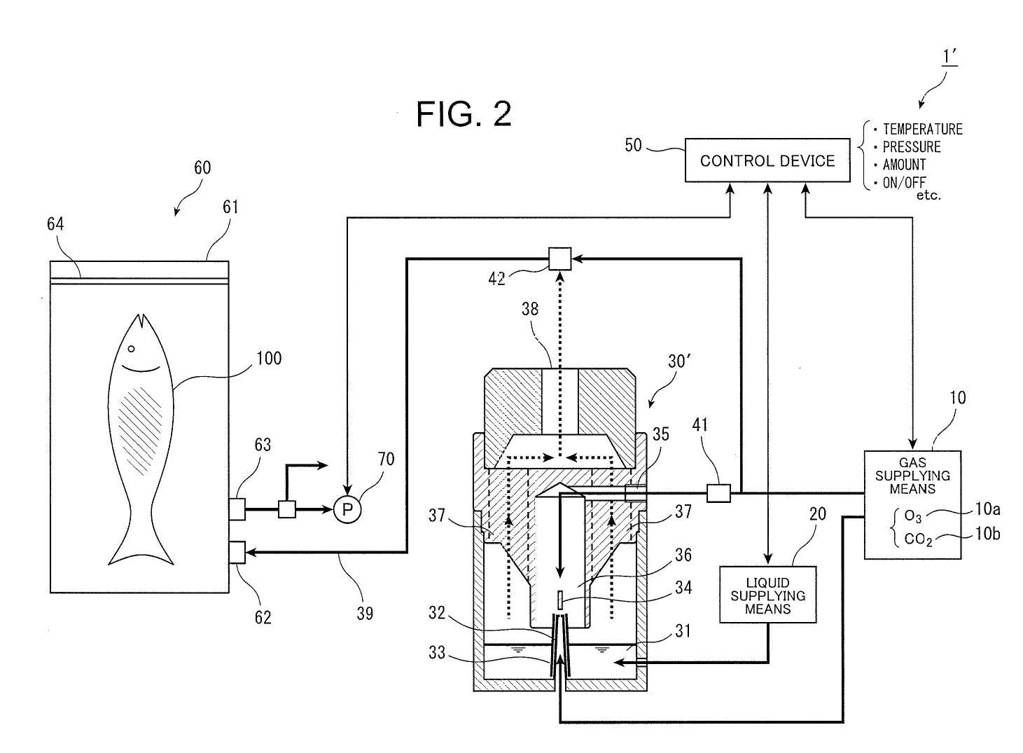

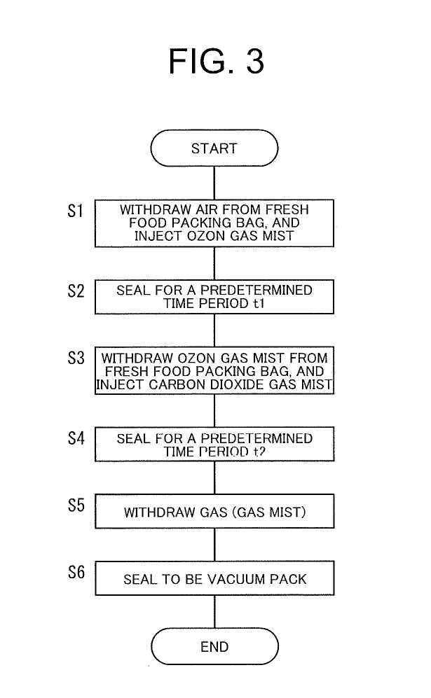

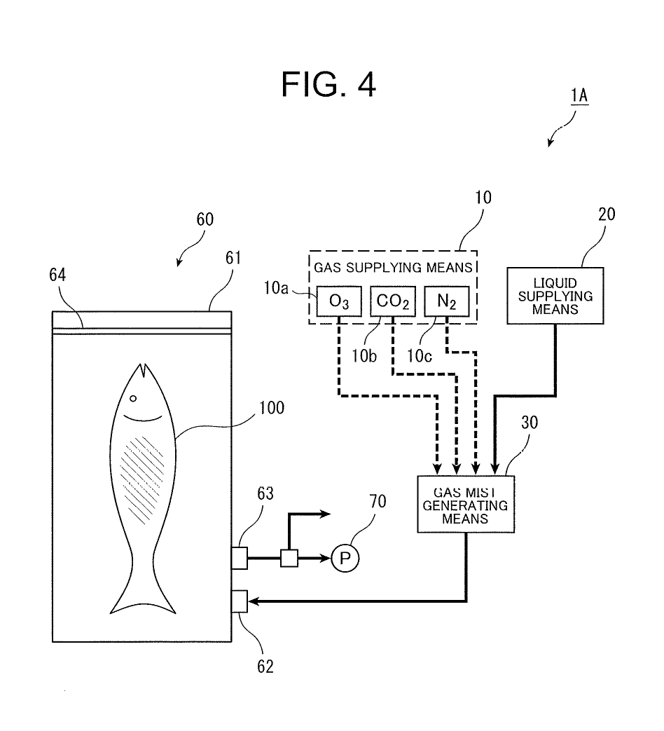

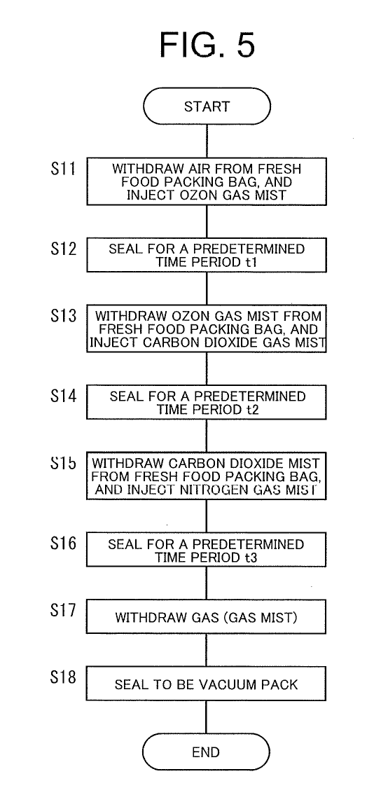

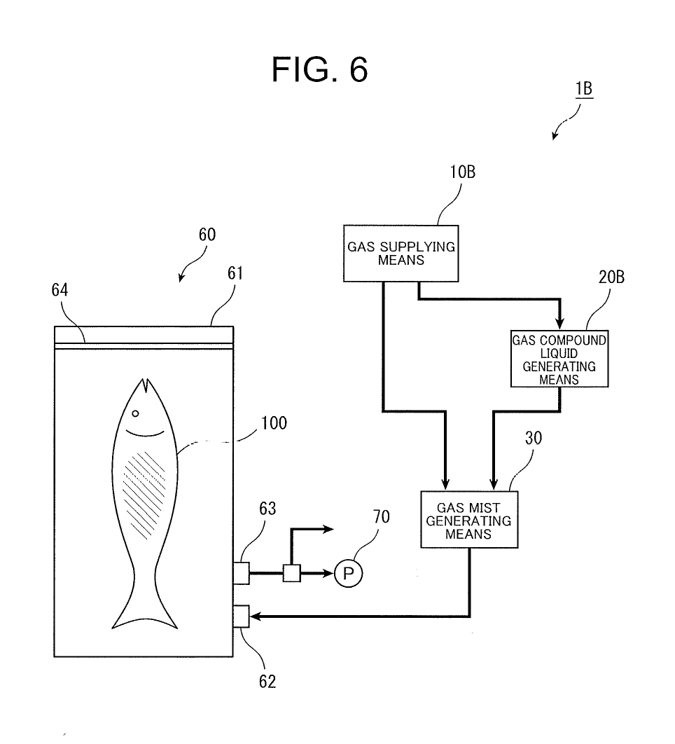

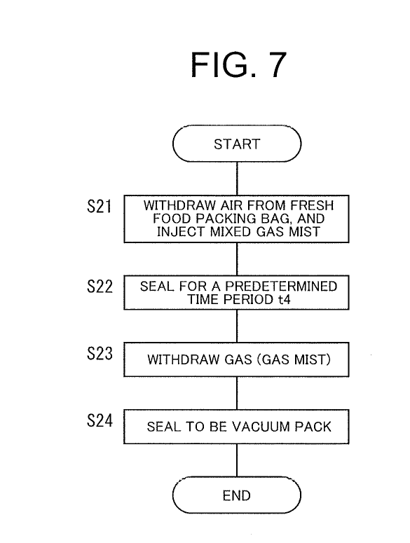

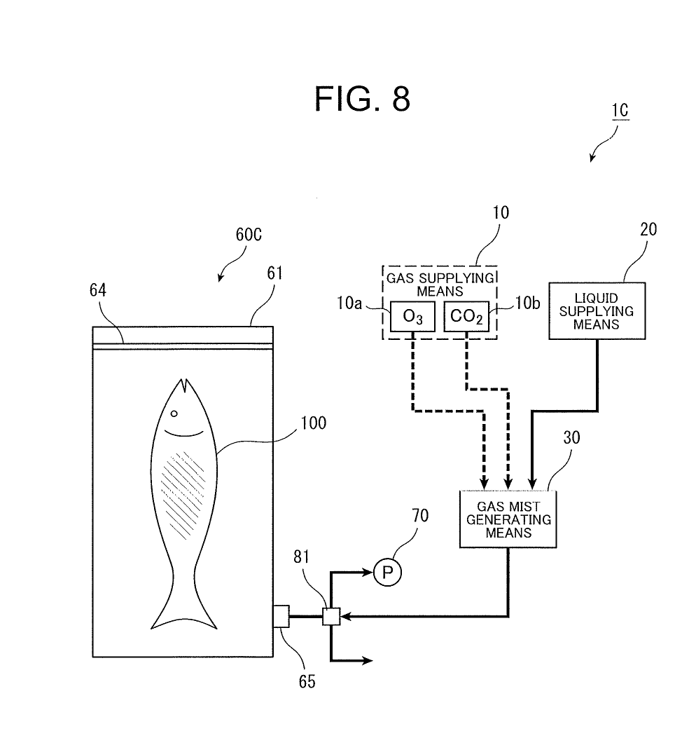

### BRIEF DESCRIPTION OF THE DRAWINGS

[FIG. 1] is a schematic view showing an outline of an apparatus for sterilizing and preserving fresh products according to an embodiment of the present invention.

[FIG. 2] is a schematic view showing a further practical example of the apparatus for sterilizing and preserving fresh products according to the present invention.

[FIG. 3] is a flowchart showing an example of the procedure when the apparatus for sterilizing and preserving fresh products according to the present invention is used.

[FIG. 4] is a schematic view showing an outline of an apparatus for sterilizing and preserving fresh products according to another embodiment of the present invention.

[FIG. 5] is a flowchart showing another example of the procedure when the apparatus for sterilizing and preserving fresh products according to the present invention is used.

[FIG. 6] is a schematic view showing an outline of an apparatus for sterilizing and preserving fresh products according to still another embodiment of the present invention.

[FIG. 7] is a flowchart showing still another example of the procedure when the apparatus for sterilizing and preserving fresh products according to the present invention is used.

[FIG. 8] is a schematic view showing an outline of an apparatus for sterilizing and preserving fresh products according to a still another embodiment of the present invention.

### MODE FOR CARRYING OUT THE INVENTION

In the following, a mode for carrying out the present invention will be explained in detail with reference to the drawings.

FIG. 1 is a schematic view showing an outline of an apparatus for sterilizing and preserving fresh products according to an embodiment of the present invention. As shown in FIG. 1, the apparatus for sterilizing and preserving fresh products 1 according to the present invention includes a gas supplying means 10 for supplying ozone gas, carbon dioxide, or mixed gas of them (herein after referred to simply as gas), a liquid supplying means 20 for supplying liquid, a gas mist generating means 30 for generating and supplying mist (herein after referred to as gas mist) which is obtained by smashing and dissolving the gas supplied from the gas supplying means 10 and the liquid from the liquid supplying means 20, a fresh food packing bag 60 for accommodating a fresh food 100 inside thereof and for forming a space for enclosing, inside thereof, the gas mist supplied from the gas mist generating means 30, and a degassing means (for example, a vacuum pump 70, an exhaust hole) for withdrawing the gas mist from the fresh food packing bag 60. When it is an exhaust hole, the gas and the gas mist in the fresh food packing bag 60 can be withdrawn so as to stop further oxidization of the fresh food after sterilization by pressing the bag by hand while the exhaust hole is opened. Note that the vacuum pump 70 may be either hand-operated one or electrically-operated one.

In addition, when needed, a control apparatus or the like may be provided so as to control the supply of gas, liquid and gas mist (see the later described FIG. 2).

The gas supplying means 10 is formed by a gas bottle or the like and includes an ozone gas supplying means 10a for supplying ozone gas to the gas mist generating means 30, and a carbon dioxide supplying means 10b for supplying carbon dioxide. Alternatively, it may be configured of a mixed gas supplying means, although it is not shown in the drawings, for supplying gas in which ozone gas and carbon dioxide are previously mixed. The gas supplying means 10 is provided with a regulator, although it is not shown in the drawings, for adjusting pressure of the gas. Further, it may be allowable to provide a gas temperature control means.

The liquid supplying means 20 is configured of a pump or the like to supply liquid to the gas mist generating means 30. Alternatively, it may be a means for generating and supplying gas mixed liquid such as, for example, an ozone water generating apparatus or the like (see later described FIG. 6). It is preferable to arrange a liquid temperature control means, the illustration diagram of which is omitted, in the liquid supplying means 20.

As the liquid to be supplied, it is preferable to use water, ion water, ozone water, physiological saline, purified water, or sterilized purified water. In addition, it may be allowable for this liquid to include addition agent appropriate to the intended fresh product 100. By including the addition agent, it is possible to penetrate the liquid together with the gas mist into the fresh product 100. Further, by adding antibacterial agent and disinfecting agent to the liquid, it is possible to increase the antibacterial effect and the disinfecting effect.

The gas mist generating means 30 is an apparatus for generating gas mist which is obtained by smashing and dissolved gas supplied from the gas supplying means 10 and liquid from the liquid supplying means 20 and for supplying it to the fresh food packing bag 60. At this time, the grain size of the generated mist is most preferably 10 μm or smaller. As the gas mist generating means 30, various mist generating apparatus such as, for example, one of an ultrasonic type, one of an atomizing type, a system employing a fluid nozzle, or the like can be applied.

The fresh food packing bag 60 is a bag having an opening portion 61 and forming a space for enclosing, inside thereof, a fresh food 100 (a fish is illustrated as an example here) and gas mist. The fresh food packing bag 60 is made of material with pressure resistance, imperviousness, and non-permeability, and has a size to cover whole of the fresh product according to the size of the fresh product 100 to be accommodated. As its practical material, for example, polyethylene, polypropylene, polyvinylidene chloride, polystyrene, polyvinyl acetate, polyvinyl chloride, resin of polyamide series, polytetrafluoroethylene, or the like is preferable.

At the opening portion 61 of the fresh food packing bag 60, an opening and closing means 64 is provided to be configured in such a way that it is opened when the fresh product 100 is accommodated and it is closed when sterilizing and preserving process is performed. For example, it is preferable to use a detachable opening and closing tool by fitting a concave tape and a convex tape referred to as zipper tapes to each other. Alternative to provide such an opening and closing means 64, the opening portion 61 may be closed by means such as a heat seal or the like.

Further, on the fresh food packing bag 60, there are provided a gas mist supplying port 62 for introducing gas mist into the inside, and an exhaust port 63 for adjusting the amount of gas mist in the fresh food packing bag 60 or for exhausting the gas mist.

To the gas mist supplying port 62, a gas mist supplying pipe 39 (see FIG. 2) is connected to supply the gas mist generated in the gas mist generating means 30 to the inside of the fresh food packing bag 60. Inside of the gas mist supplying port 62, a check valve is provided to prevent the gas mist from flowing back.

The exhaust port 63 is a vent for exhausting gas or gas mist in the fresh food packing bag 60. To the exhaust port 63, a vacuum pump 70 is connected. The vacuum pump 70 is a means (a hand-operated pump, an electrically-operated pump, or a degassing opening) for withdrawing the gas and the gas mist from the fresh food packing bag 60.

FIG. 2 shows a further practical example of the above described apparatus for sterilizing and preserving fresh products 1. Here, an apparatus for sterilizing and preserving fresh products 1′ employing an atomizing gas mist generating means 30′ is shown. Note that the same parts as those in FIG. 1 are denoted by the same symbols and the detailed explanations thereof are omitted here.

As shown in FIG. 2, in the gas mist generating means 30′, there are formed a fluid accumulation portion 31 for accumulating liquid from the liquid supplying means 20, a nozzle 32 for discharging gas supplied from the gas supplying means 10 through a tip opening, a liquid absorbing pipe 33 for absorbing the liquid accumulated in the liquid accumulating portion 31 to the tip of the nozzle 32, and a baffle 34 provided at a position opposite to the tip openings of the nozzle 32 and the liquid absorbing pipe 33. In addition, it includes a gas supplying portion 35 and a gas introducing portion 36 for supplying gas from the gas supplying means 10 to the inside of the gas mist generating means 30′, and for introducing the gas around the nozzle 32 and for generating aerial current for exhausting the gas mist, and a gas mist collecting portion 37 and a gas mist derivation portion 38 for collecting and exhausting the gas mist. The gas mist exhausted from the gas mist derivation portion 38 is supplied through a gas mist supplying pipe 39 to the fresh food packing bag 60.

When gas mist is generated by this gas mist generating means 30′, at first, a predetermined amount of liquid is injected from the liquid supplying means 20 into the liquid accumulating portion 31, and then gas is supplied from the gas supplying means 10 to the nozzle 32 and the gas supplying portion 35. When the gas is supplied to the nozzle 32, the gas is discharged with increasing flow rate because the nozzle 32 is narrowed along the direction to the top end as shown in FIG. 2. The liquid is absorbed up to the liquid absorbing pipe 33 by a negative pressure generated by the aerial current at this time, and is blown up by the gas exhausted from the nozzle 32 at the top end portion of the liquid absorbing pipe 33 so as to collide with the baffle 34 to generate the gas mist. Gas is further supplied form the gas supplying portion 35 and the gas introducing portion 36 into the gas mist generating means 30′, so as to higher the exhausting pressure of the generated gas mist. The generated gas mist passes through the gas mist collecting portion 37 and the gas mist derivation portion 38 and is supplied from the gas mist supplying pipe 39 to the fresh food packing bag 60. It is preferable that the gas mist is enclosed in the fresh food packing bag 60 with an appropriate pressurization (about around 1.02-2.5 atmosphere).

Note that the apparatus for sterilizing and preserving fresh products 1′ includes a control device 50 as shown in FIG. 2. The control device 50 includes a computer having a CPU, a memory, and a display to perform various controls such as temperature control, supplying pressure control, supplying amount control, turning On or Off of the supply of the gas or the liquid from the gas supplying means 10 or the liquid supplying means 20, switching the valve, driving the vacuum pump 70, or the like.

In addition, in the apparatus for sterilizing and preserving fresh products 1′, a flow valve 41 is provided between the gas supplying means 10 and the gas supplying portion 35 of the gas mist generating means 30′ so as to make it possible to adjust the flow rate of the gas to the gas mist generating means 30′, and the gas mist supplying pipe 39 is provided with a switch valve 42 for switching the gas mist from the gas mist derivation portion 38 of the gas mist generating means 30′ and the gas from the gas supplying means 10 so as to make it possible to adjust the gas concentration and to adjust the amount of the gas mist in the fresh food packing bag 60.

Next, a sequence to use the above-described apparatus for sterilizing and preserving fresh products 1′ will be explained with reference to FIG. 3.

At first, in the state in which the fresh product 100 is accommodated in the fresh food packing bag 60, the air in the fresh food packing bag 60 is withdrawn from the exhaust port 63, and ozone gas mist is generated by the gas mist generating means 30 and is injected into the fresh food packing bag 60 (step S1).

Next, after injecting an appropriate amount of the ozone gas mist into the fresh food packing bag 60, supplying the ozone gas mist is stopped, and the sealed state is kept as it is for a predetermined time period (t1) (step S2).

Then, the ozone gas mist in the fresh food packing bag 60 is withdrawn from the exhaust port 63, and carbon dioxide gas mist is generated by the gas mist generating means 30 and is injected into the fresh food packing bag 60 (step S3).

Then, when an appropriate amount of the carbon dioxide gas mist is injected into the fresh food packing bag 60, supplying the carbon dioxide gas mist is stopped, and the sealed state is kept as it is for a predetermined time period (t2) (step S4).

Then, the carbon dioxide gas mist in the fresh food packing bag 60 is withdrawn by the vacuum pump 70 (step S5).

Then, the vacuum fresh food packing bag 60 is sealed so that the fresh product 100 is vacuum-packed (step S6). In this state, shipping, transferring, or preserving of the fresh product 100 is carried out. Thus, the process of the sterilizing and preserving of the fresh product 100 is completed.

Note that, in the above description, as the gas supplied from the gas supplying means 10, ozone gas and carbon dioxide are used, however, in addition to them, it may also be possible to use nitrogen gas in order to prevent it from being oxidized. FIG. 4 shows an outline of an apparatus for sterilizing and preserving fresh products 1A having a nitrogen gas supplying means 10c. Note that the same parts in the embodiment shown in FIG. 1 are denoted by the same symbols and the detailed explanation thereof is omitted here. FIG. 5 is a flowchart showing the procedure when the apparatus for sterilizing and preserving fresh products 1A is used.

As shown in these figures, the fresh apparatus for sterilizing and preserving fresh products 1A includes, as an ozone gas supplying means 10A, a nitrogen gas supplying means 10c, in addition to the ozone gas supplying means 10a and the carbon dioxide supplying means 10b. The nitrogen gas supplying means 10c supplies nitrogen gas to the gas mist generating means 30.

When sterilizing and preserving of a fresh product is to be performed, at first, in a state where the fresh product 100 is accommodated in the fresh food packing bag 60, air in the fresh food packing bag 60 is withdrawn from the exhaust port 63, ozone gas mist is generated by the gas mist generating means 30, and is injected into the fresh food packing bag 60 (step S11).

Then, when an appropriate amount of the ozone gas mist is injected into the fresh food packing bag 60, supplying the ozone gas mist is stopped, and the sealed state is kept as it is for a predetermined time period (t1) (step S12).

Then, the ozone gas mist in the fresh food packing bag 60 is withdrawn from the exhaust port 63, and carbon dioxide gas mist is generated by the gas mist generating means 30 and is injected into the fresh food packing bag 60 (step S13).

Then, when an appropriate amount of the carbon dioxide gas mist is injected into the fresh food packing bag 60, supplying the carbon dioxide gas mist is stopped, and the sealed state is kept as it is for a predetermined time period (t2) (step S14).

Then, the carbon dioxide gas mist in the fresh food packing bag 60 is withdrawn from the exhaust port 63, and nitrogen gas mist is generated by the gas mist generating means 30 and is injected into the fresh food packing bag 60 (step S15).

Then, when an appropriate amount of the nitrogen gas mist is injected into the fresh food packing bag 60, supplying the nitrogen gas mist is stopped, and the sealed state is kept as it is for a predetermined time period (t3) (step S16).

Then, the gas mist in the fresh food packing bag 60 is withdrawn by the vacuum pump 70 (step S17).

Then, the vacuum fresh food packing bag 60 is sealed so that the fresh product 100 is vacuum-packed (step S18). In this state, shipping, transferring, or preserving of the fresh product 100 is carried out. Thus, the process of the sterilizing and preserving of the fresh product 100 is completed.

The liquid supplying means 20 may be replaced by a gas compound liquid generating means as mentioned before. FIG. 6 shows its outline. As shown in FIG. 6, an apparatus for sterilizing and preserving fresh products IB includes a gas compound liquid generating means 20B as a liquid supplying means to the gas mist generating means 30. Here, a gas supplying means 10B of the apparatus for sterilizing and preserving fresh products 1B is provided to be able to supply gas to not only the gas mist generating means 30 but also the gas compound liquid generating means 20B. The gas compound liquid generating means 20B integrates the gas supplied from the gas supplying means 10 with liquid to make liquid compound with gas.

Practically, it is preferable to be a microbubble compound liquid generating means for uniformly involving, in the liquid, microbubbles which are miniaturized to have grain sizes difficult to he disappeared (preferably, the size of each bubble is 4 to 50 micrometers) and for supplying the liquid involving the microbubbles. The microbubble compound liquid generating means is constructed by, for example, a mixing pump for introducing and mixing gas and liquid, and a line mixer or the like including a stirring means having a plurality of projections for making the gas included in the liquid from the mixing pump to collide with and to stir by the plurality of projections in a state of being under a flowing water pressure in a closed flowing water path so as to miniaturize bubbles in the gas included in the liquid from the mixing pump to be microbubbles.

Note that, in the above-described embodiment, the processes to contact the fresh product 100 with ozone gas mist, carbon dioxide gas mist, and nitrogen gas mist are respectively separate processes, however, it may also be possible to reduce them into one process by generating gas mist from mixed gas of ozone gas and carbon dioxide (or mixed gas of ozone gas, carbon dioxide, and nitrogen gas). FIG. 7 shows this procedure.

At first, in a state where the fresh product 100 is accommodated in the fresh food packing bag 60, air in the fresh food packing bag 60 is withdrawn from the exhaust port 63, and mixed gas is generated by the gas mist generating means 30 and is injected into the fresh food packing bag 60 (step S21).

Next, when an appropriate amount of the mixed gas mist is injected into the fresh food packing bag 60, supplying the ozone gas mist is stopped, and the sealed state is kept as it is for a predetermined time period (t4) (step S22).

Then, the gas mist in the fresh food packing bag 60 is withdrawn by the vacuum pump 70 (step S23).

Then, the vacuum fresh food packing bag 60 is sealed so that the fresh product 100 is vacuum-packed (step S24). In this state, shipping, transferring, or preserving of the fresh product 100 is carried out. Thus, the process of the sterilizing and preserving of the fresh product 100 is completed.

In the above description, the fresh food packing bag 60 is provided with the gas mist supplying port 62 and the exhaust port 63 separately, however, they may be combined. An apparatus for sterilizing and preserving fresh products 1C shown in FIG. 8 includes a gas mist supplying and exhausting port 65 combining both in place of the gas mist supplying port and the exhaust port. In the apparatus for sterilizing and preserving fresh products 1C, the switching between supplying the gas mist to and exhausting the gas mist from the fresh food packing bag 60 is performed by an operation of a switching valve 81. When gas mist is to be injected into the fresh food packing bag 60C, at first, gas in the fresh food packing bag 60C is exhausted from the gas mist supplying and exhausting port 65, and then the switching valve 81 is switched to inject the gas mist. As such, by the single gas mist supplying and exhausting port 65 combining the gas mist supplying port and exhausting port, the construction of the fresh food packing bag 60C can be reduced and simplified.

As described above, by the apparatus and the method for sterilizing and preserving fresh products according to the present invention, a fresh product is made to be in contact with ozone gas mist and carbon dioxide gas mist so that sterilization, inactivation of virus, prevention of bacteria, fungi, destructive insects, or the like from being generated can be performed as well as freshness of the fresh product can be kept and change of properties or deterioration of quality can be suppressed so as to improve the shelf life. Therefore, it becomes possible to reduce agricultural chemicals or preservation agent.

Both of the ozone gas and the carbon dioxide used in the present invention have no persistent toxicity so that, even when the apparatus for sterilizing and preserving fresh products is used for food product, it is very safe.

Note that the present invention is not limited to the above-described embodiments but various modifications are possible based on the concept of the present invention, and they are not excluded from the scope of the present invention.

### INDUSTRIAL APPLICABILITY

The present invention relates to an apparatus and a method for sterilizing and preserving fresh products by using ozone gas, carbon dioxide, or mixed gas of them to sterilize a fresh product and to improve the shelf life, and therefore has an industrial applicability.

### EXPLANATION OF SYMBOLS

1, 1′, 1A, 1B, 1C apparatus for sterilizing and preserving fresh products
10, 10A gas supplying means
10a ozone gas supplying means
10b carbon dioxide supplying means
10c nitrogen gas supplying means
20 liquid supplying means
20B gas compound liquid generating means
30, 30′ gas mist generating means
31 liquid accumulating portion
32 nozzle
33 liquid absorbing pipe
34 baffle
35 gas supplying portion
36 gas introducing portion
37 gas mist collecting portion
38 gas mist derivation portion
39 gas mist supplying pipe
41 flow valve
42 switch valve
50 control device
60, 60C fresh food packing bag
61 opening portion
62 gas mist supplying port
63 exhaust port
64 opening and closing means
70 vacuum pump
81 switching valve
100 fresh product

1. An apparatus for sterilizing and preserving fresh products comprising:
a gas supplying means for supplying ozone gas, carbon dioxide, or mixed gas of them (herein after referred to as “gas”);
a liquid supplying means for supplying liquid;
a gas mist generating means for generating mist (herein after referred to as “gas mist”) which is obtained by smashing and dissolving the gas and the liquid supplied from the supplying means and the liquid supplying means;
a fresh food packing bag for accommodating a fresh food inside thereof and for forming a space for enclosing, inside thereof, the gas mist supplied from the gas mist generating means; and
a degassing means for withdrawing the gas mist from the fresh food packing bag;
wherein the ozone gas and the carbon dioxide in a state of the gas mist being made to be in contact with the fresh product to sterilize and to keep freshness of the fresh product.

2. The apparatus according to claim 1, further comprising a control means for performing various controls in the apparatus for sterilizing and preserving fresh products.

3. The apparatus according to claim 1, wherein the gas supplying means further supplies nitrogen gas or mixed gas of ozone gas, carbon dioxide and nitrogen gas.

4. The apparatus according to claim 1, wherein the liquid supplying means is a gas compound liquid generating and supplying means for miniaturizing bubbles of the gas and for involving them in the liquid.

5. The apparatus according to claims 4, wherein the gas compound liquid generating and supplying means miniaturizes the bubbles of gas into microbubbles each of which has a size of 4 to 50 micrometers and involves them into the liquid.

6. A method for sterilizing and preserving fresh products comprising:
(a) a step of withdrawing air form a fresh food packing bag which accommodates a fresh product, and of injecting ozone gas mist which is mist (herein after referred to as “gas mist”) obtained by smashing and dissolving ozone gas and liquid;
(b) a step of sealing the fresh food packing bag for a predetermined time period t1 so as to make the fresh product to be in contact with the ozone gas mist;
(c) a step of withdrawing the ozone gas mist from the fresh food packing bag and of injecting carbon dioxide gas mist, which is obtained by smashing and dissolving the carbon dioxide and the liquid, into the fresh food packing bag;
(d) a step of sealing the fresh food packing bag for a predetermined time period t2 so as to make the fresh product to be in contact with the carbon dioxide gas mist;
(e) a step of withdrawing the carbon dioxide gas mist from the fresh food packing bag; and
(f) a step of sealing the fresh food packing bag to be a vacuum pack,
wherein the ozone gas and the carbon dioxide in a state of the gas mist being made to be in contact with the fresh product to sterilize and to keep freshness of the fresh product.

7. The method according to claims 6, further comprising, between the step (d) and the step (e),
(g) a step of withdrawing the ozone gas mist from the fresh food packing bag, and of injecting nitrogen gas mist, which is obtained by smashing and dissolving the nitrogen gas and the liquid, into the fresh food packing bag; and
(h) a step of sealing the fresh food packing bag for a predetermined time period t3 so as to make the fresh product to be in contact with the nitrogen gas mist.

8. A method for sterilizing and preserving fresh products comprising:
(a) a step of withdrawing air from a fresh food packing bag accommodating a fresh product, and of injecting mixed gas mist which is mist (herein after referred to as “gas mist”) obtained by smashing and dissolving mixed gas of ozone gas and carbon dioxide and liquid;
(b) a step of sealing the fresh food packing bag for a predetermined time period t4 so as to make the fresh product to be in contact with the mixed gas mist;
(c) a step of withdrawing the mixed gas mist from the fresh food packing bag; and
(d) a step of sealing the fresh food packing bag to be a vacuum pack,
wherein the ozone gas and the carbon dioxide in a state of the gas mist being made to be in contact with the fresh product to sterilize and to keep freshness of the fresh product.

9. The method according to claim 8, wherein nitrogen gas is further added to the mixed gas.
